(19) United States
(12) Patent Application Publication
(10) Pub. No.: US 2006/0158732 A1
(43) Pub. Date: Jul. 20, 2006

(54) Red/cyan filters for viewing 3d photos printed on home computers and printers

(76) Inventor: Samer Ramadan, Exeter, NH (US)

Correspondence Address: Philip Decker, Suite 125, 1 New Hampshire Avenue, Portsmouth, NH, 03801, US

(21) Appl. No.: 10/564,026

(22) PCT Filed: Jul. 9, 2004
(86) PCT No.: PCT/US04/23026

§ 371 Date: Jan. 9, 2006

Related U.S. Application Data
(60) Provisional application No. 60/485,839, filed on Jul. 9, 2003.

(51) Int. Cl. G02B 27/22

(52) U.S. Cl. 359/464; 359/891

(57) ABSTRACT

A pair of optical filters that are designed and optimized for viewing 3D photos printed on home computer inkjet printers. The pair has a red colored filter having a transmittance (10) of greater than 60% with 610 nm and greater wavelength light, and a cyan colored filter having a transmittance peak (12) of greater than 60% with 480 nm wavelength lights and a transmittance of greater than 50% with 700 nm (14) and greater wavelength.

### BACKGROUND

1. Field of the Invention

The invention is related to colored lenses for enabling the user to view 3D pictures.

2. Description of the Related Art

3D stereoscopy has been known for over a hundred years. Well-known examples of 3D stereoscopy in popular use include the VIEW MASTER reels and 3D movies of the 1950s and later. However, since the arrival of personal computers and color inkjet printers, there has been no 3D viewer filters designed for pictures produced by them. The color spectra seen by viewing a picture printed by an inkjet printer can be different from the color spectra seen by viewing a picture made using the standard chemical photographic process. The red/cyan viewers available for red/cyan photographs do not result in clean, ghost-free images. What is needed, therefore, are filters designed and optimized for viewing 3D photos printed on home computer inkjet printers.

### SUMMARY

Optical filters that are designed and optimized for viewing 3D photos printed on home computer inkjet printers have a red filter having a transmittance of greater than 60% with 610 nm and greater wavelength light, and a cyan colored filter having a transmittance peak of greater than 60% with 480 nm wavelength light and a transmittance of greater than 50% with 700 nm and greater wavelength light. These and other features and embodiments of the invention will be made clear in the following drawings, description, and claims.

### DRAWINGS

FIG. 1 is a graph of percent transmittance plotted against wavelength for the red lens.

FIG. 2 is a graph of percent transmittance plotted against wavelength for the cyan/blue lens.

### DESCRIPTION

The invention is a pair of optical filters that are designed and optimized for viewing 3D photos printed on home computer inkjet printers. The pair has a red colored filter having a transmittance of greater than 60% with 610 nm and greater wavelength light, and a cyan colored filter having a transmittance peak of greater than 60% with 480 nm wavelength light and a transmittance of greater than 50% with 700 nm and greater wavelength light.

The filters result in clear, ghost-free, sharp images that are likely to greatly increase acceptance of anaglyph 3D viewing. The characteristics of the filters are best described by the following tables of information. The transmittance values are +/−5%.

Red Lens Specifications:

Luminous Transmittance (Tv): 13.8786650%
Filter Category: 3
MAX Tf 260 nm-315 nm: (<0.1 Tv) 0.000=→PASS
MAX Tf 315 nm-350 nm: (<0.5 Tv) 0.000=→PASS
MAX TSUVA 315 nm-380 nm: (<0. Tv) 0.00000=→PASS
Min Tv 500 nm-650 nm: (>0.2 Tv) 0.000=→FAIL
   UV Transmittance:
TSUVA (<0.00000+0.5): 0.00000=→PASS
TSUVB (<0.00000+0.5): 0.00000=→PASS
   Blue Light Transmittance:
Tsb 380 nm-500 nm (<0.00000+0.5): 0.00000=→-Reference
   Recognition of Signal Lights:
Red (Q) Factor (>0.8): 5.101=→PASS
Yellow (Q) Factor (>0.8): 2.320=→PASS
Green (Q) Factor (>0.6): 0.120=→FAIL

Blue (Q) Factor (>0.4): 0.715=→PASS

TABLE 1

| WL | | WL | | WL | | WL | | WL | |
|---|---|---|---|---|---|---|---|---|---|
| (nm) | T % | (nm) | T % | (nm) | T % | (nm) | T % | (nm) | T % |
| 780 | 91.903 | 770 | 92.161 | 760 | 92.448 | 750 | 92.722 | 740 | 92.917 |
| 730 | 92.717 | 720 | 92.326 | 710 | 91.811 | 700 | 91.462 | 690 | 91.345 |
| 680 | 91.542 | 670 | 91.612 | 660 | 81.412 | 650 | 90.614 | 640 | 89.146 |
| 630 | 86.667 | 620 | 81.662 | 610 | 69.871 | 600 | 46.158 | 590 | 16.359 |
| 580 | 1.864 | 570 | 0.047 | 560 | 0.000 | 550 | 0.000 | 540 | 0.000 |
| 530 | 0.000 | 520 | 0.000 | 510 | 0.000 | 500 | 0.000 | 490 | 0.000 |
| 480 | 0.000 | 470 | 0.000 | 460 | 0.000 | 450 | 0.000 | 440 | 0.000 |
| 430 | 0.000 | 420 | 0.000 | 410 | 0.000 | 400 | 0.000 | 390 | 0.000 |
| 380 | 0.000 | 370 | 0.000 | 360 | 0.000 | 350 | 0.000 | 340 | 0.000 |
| 330 | 0.000 | 320 | 0.000 | 310 | 0.000 | 300 | 0.000 | 290 | 0.000 |
| 280 | 0.000 | | | | | | | | |

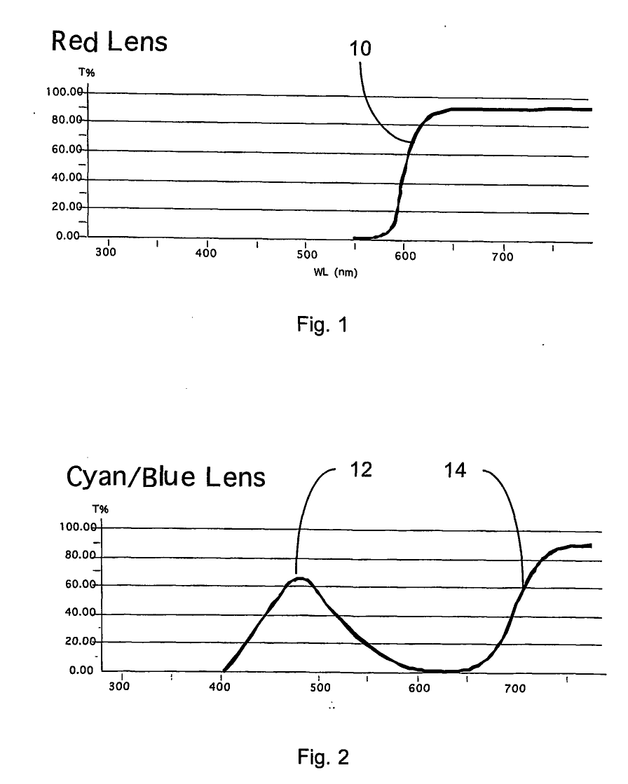

These data are plotted as the curve 10 of FIG. 1.
Cyan (Blue) Lens Specifications:
Luminous Transmittance (Tv): 20.3037224%
Filter Category: 2
MAX Tf 260 nm-315 nm: (<0.1 Tv) 0.000=→PASS
MAX Tf 315 nm-350 nm: (<0.5 Tv) 0.000=→PASS
MAX TSUVA 315 nm-380 nm: (<0. Tv) 0.00000=→PASS
Min Tv 500 nm-650 nm: (>0.2 Tv) 0.000=→FAIL
   UV Transmittance:
TSUVA (<0.00000+0.5): 0.00000=→PASS
TSUVB (<0.00000+0.5): 0.00000=→PASS
   Blue Light Transmittance:
Tsb 380 nm-500 nm (<31.98323+0.5): 40.1871=→-Reference
   Recognition of Signal Lights:
Red (Q) Factor (>0.8): 0.175=→FAIL
Yellow (Q) Factor (>0.8): 0.346=→FAIL
Green (Q) Factor (>0.6): 1.413=→PASS

Blue (Q) Factor (>0.4): 1.930=→PASS

TABLE 2

| WL | | WL | | WL | | WL | | WL | |
|---|---|---|---|---|---|---|---|---|---|
| (nm) | T % | (nm) | T % | (nm) | T % | (nm) | T % | (nm) | T % |
| 780 | 92.144 | 770 | 91.478 | 760 | 90.844 | 750 | 90.296 | 740 | 89.580 |
| 730 | 87.446 | 720 | 82.453 | 710 | 72.361 | 700 | 56.497 | 690 | 37.370 |
| 680 | 20.510 | 670 | 9.744 | 660 | 4.616 | 650 | 2.657 | 640 | 2.128 |
| 630 | 2.260 | 620 | 2.539 | 610 | 2.574 | 600 | 2.617 | 590 | 3.287 |
| 580 | 5.182 | 570 | 0.262 | 560 | 11.744 | 550 | 15.936 | 540 | 22.629 |
| 530 | 31.805 | 520 | 40.710 | 510 | 48.506 | 500 | 56.496 | 490 | 62.925 |
| 480 | 64.320 | 470 | 60.939 | 460 | 54.323 | 450 | 43.995 | 440 | 31.496 |
| 430 | 21.451 | 420 | 14.386 | 410 | 5.358 | 400 | 0.115 | 390 | 0.000 |
| 380 | 0.000 | 370 | 0.000 | 360 | 0.000 | 350 | 0.000 | 340 | 0.000 |
| 330 | 0.000 | 320 | 0.000 | 310 | 0.000 | 300 | 0.000 | 290 | 0.000 |
| 280 | 0.000 | | | | | | | | |

These data are plotted as the curves of FIG. 2. As is shown in Table 2 and FIG 2, the blue/cyan colored lens has a transmittance peak 12 of greater than 60% with 480 nm wavelength light. It is also shown that the transmittance 14 exceeds 50% with 700 nm and greater wavelength light.

While there have been described what are at present considered to be preferred embodiments of this invention, it will be obvious to those skilled in the art that various changes and modifications may be made therein without departing from the invention and it is, therefore, aimed to cover all such changes and modifications as fall within the true spirit and scope of the invention.

I claim:

1. Optical filters for viewing 3D photos printed on an inkjet printer comprising:
a red colored filter having a transmittance of greater than 60% with 610 nm and greater wavelength light, and
a cyan colored filter having a transmittance peak of greater than 60% with 480 nm wavelength light and a transmittance of greater than 50% with 700 nm and greater wavelength light.

2. The optical filters of claim 1, wherein the red colored filter has transmittance values at particular wavelengths according to this table, plus or minus five percent:

| WL | | WL | | WL | | WL | | WL | |
|---|---|---|---|---|---|---|---|---|---|
| (nm) | T % | (nm) | T % | (nm) | T % | (nm) | T % | (nm) | T % |
| 780 | 91.903 | 770 | 92.161 | 760 | 92.448 | 750 | 92.722 | 740 | 92.917 |
| 730 | 92.717 | 720 | 92.326 | 710 | 91.811 | 700 | 91.462 | 690 | 91.345 |
| 680 | 91.542 | 670 | 91.612 | 660 | 81.412 | 650 | 90.614 | 640 | 89.146 |
| 630 | 86.667 | 620 | 81.662 | 610 | 69.871 | 600 | 46.158 | 590 | 16.359 |
| 580 | 1.864 | 570 | 0.047 | 560 | 0.000 | 550 | 0.000 | 540 | 0.000 |
| 530 | 0.000 | 520 | 0.000 | 510 | 0.000 | 500 | 0.000 | 490 | 0.000 |
| 480 | 0.000 | 470 | 0.000 | 460 | 0.000 | 450 | 0.000 | 440 | 0.000 |
| 430 | 0.000 | 420 | 0.000 | 410 | 0.000 | 400 | 0.000 | 390 | 0.000 |
| 380 | 0.000 | 370 | 0.000 | 360 | 0.000 | 350 | 0.000 | 340 | 0.000 |
| 330 | 0.000 | 320 | 0.000 | 310 | 0.000 | 300 | 0.000 | 290 | 0.000 |
| 280 | 0.000 | | | | | | | | |

3. The optical filters of claim 1, wherein the cyan colored filter has transmittance values at particular wavelengths according to this table, plus or minus five percent:

| WL | | WL | | WL | | WL | | WL | |
|---|---|---|---|---|---|---|---|---|---|
| (nm) | T % | (nm) | T % | (nm) | T % | (nm) | T % | (nm) | T % |
| 780 | 92.144 | 770 | 91.478 | 760 | 90.844 | 750 | 90.296 | 740 | 89.580 |
| 730 | 87.446 | 720 | 82.453 | 710 | 72.361 | 700 | 56.497 | 690 | 37.370 |
| 680 | 20.510 | 670 | 9.744 | 660 | 4.616 | 650 | 2.657 | 640 | 2.128 |
| 630 | 2.260 | 620 | 2.539 | 610 | 2.574 | 600 | 2.617 | 590 | 3.287 |
| 580 | 5.182 | 570 | 0.262 | 560 | 11.744 | 550 | 15.936 | 540 | 22.629 |
| 530 | 31.805 | 520 | 40.710 | 510 | 48.506 | 500 | 56.496 | 490 | 62.925 |
| 480 | 64.320 | 470 | 60.939 | 460 | 54.323 | 450 | 43.995 | 440 | 31.496 |
| 430 | 21.451 | 420 | 14.386 | 410 | 5.358 | 400 | 0.115 | 390 | 0.000 |
| 380 | 0.000 | 370 | 0.000 | 360 | 0.000 | 350 | 0.000 | 340 | 0.000 |
| 330 | 0.000 | 320 | 0.000 | 310 | 0.000 | 300 | 0.000 | 290 | 0.000 |
| 280 | 0.000 | | | | | | | | |

4. 3D glasses for viewing 3D photos printed on an inkjet printer comprising:
a red colored filter having a transmittance of greater than 60% with 610 nm and greater wavelength light,
a cyan colored filter having a transmittance peak of greater than 60% with 480 nm wavelength light and a transmittance of greater than 50% with 700 nm and greater wavelength light, and
an eyeglass frame for holding the red colored filter in a spaced relationship with the cyan colored filter.

5. The 3D glasses of claim 4 wherein the frame is designed to place the red colored filter over a wearer's left eye and place the cyan colored filter over a wearer's right eye.

6. The 3D glasses of claim 4 wherein the red colored filter has transmittance values at particular wavelengths according to this table, plus or minus five percent:

| WL | | WL | | WL | | WL | | WL | |
|---|---|---|---|---|---|---|---|---|---|
| (nm) | T % | (nm) | T % | (nm) | T % | (nm) | T % | (nm) | T % |
| 780 | 91.903 | 770 | 92.161 | 760 | 92.448 | 750 | 92.722 | 740 | 92.917 |
| 730 | 92.717 | 720 | 92.326 | 710 | 91.811 | 700 | 91.462 | 690 | 91.345 |
| 680 | 91.542 | 670 | 91.612 | 660 | 81.412 | 650 | 90.614 | 640 | 89.146 |
| 630 | 86.667 | 620 | 81.662 | 610 | 69.871 | 600 | 46.158 | 590 | 16.359 |
| 580 | 1.864 | 570 | 0.047 | 560 | 0.000 | 550 | 0.000 | 540 | 0.000 |
| 530 | 0.000 | 520 | 0.000 | 510 | 0.000 | 500 | 0.000 | 490 | 0.000 |
| 480 | 0.000 | 470 | 0.000 | 460 | 0.000 | 450 | 0.000 | 440 | 0.000 |
| 430 | 0.000 | 420 | 0.000 | 410 | 0.000 | 400 | 0.000 | 390 | 0.000 |
| 380 | 0.000 | 370 | 0.000 | 360 | 0.000 | 350 | 0.000 | 340 | 0.000 |
| 330 | 0.000 | 320 | 0.000 | 310 | 0.000 | 300 | 0.000 | 290 | 0.000 |
| 280 | 0.000 | | | | | | | | |

7. The 3D glasses of claim 4 wherein the cyan colored filter has transmittance values at particular wavelengths according to this table, plus or minus five percent:

| WL | | WL | | WL | | WL | | WL | |
|---|---|---|---|---|---|---|---|---|---|
| (nm) | T % | (nm) | T % | (nm) | T % | (nm) | T % | (nm) | T % |
| 780 | 92.144 | 770 | 91.478 | 760 | 90.844 | 750 | 90.296 | 740 | 89.580 |
| 730 | 87.446 | 720 | 82.453 | 710 | 72.361 | 700 | 56.497 | 690 | 37.370 |
| 680 | 20.510 | 670 | 9.744 | 660 | 4.616 | 650 | 2.657 | 640 | 2.128 |
| 630 | 2.260 | 620 | 2.539 | 610 | 2.574 | 600 | 2.617 | 590 | 3.287 |
| 580 | 5.182 | 570 | 0.262 | 560 | 11.744 | 550 | 15.936 | 540 | 22.629 |
| 530 | 31.805 | 520 | 40.710 | 510 | 48.506 | 500 | 56.496 | 490 | 62.925 |
| 480 | 64.320 | 470 | 60.939 | 460 | 54.323 | 450 | 43.995 | 440 | 31.496 |
| 430 | 21.451 | 420 | 14.386 | 410 | 5.358 | 400 | 0.115 | 390 | 0.000 |
| 380 | 0.000 | 370 | 0.000 | 360 | 0.000 | 350 | 0.000 | 340 | 0.000 |
| 330 | 0.000 | 320 | 0.000 | 310 | 0.000 | 300 | 0.000 | 290 | 0.000 |
| 280 | 0.000 | | | | | | | | |
